(19) United States
(12) Patent Application Publication
(10) Pub. No.: US 2022/0358161 A1
(43) Pub. Date: Nov. 10, 2022

(54) METHOD AND APPARATUS FOR DATA SLICING BASED ON INFORMATION CENTRIC NETWORK

(71) Applicant: ELECTRONICS AND TELECOMMUNICATIONS RESEARCH INSTITUTE, Daejeon (KR)

(72) Inventors: Kang Il CHOI, Daejeon (KR); Jung Hee LEE, Daejeon (KR); Yong Bin YIM, Daejeon (KR)

(73) Assignee: ELECTRONICS AND TELECOMMUNICATIONS RESEARCH INSTITUTE, Daejeon (KR)

(21) Appl. No.: 17/556,342

(22) Filed: Dec. 20, 2021

(30) Foreign Application Priority Data
May 6, 2021 (KR) 10-2021-0058319
Oct. 22, 2021 (KR) 10-2021-0141828

(51) Int. Cl. G06F 16/901; G06F 9/448

(52) U.S. Cl. CPC G06F 16/901; G06F 9/4494

(57) ABSTRACT

Disclosed herein are a method and apparatus for data slicing in an information centric network (ICN) system. According to the present disclosure, the method may include, by an IoT terminal device provided in the ICN system, receiving a creation request for slice data from an application, processing registration of the slice data, and processing publication of the slice data, wherein the slice data may include sensor data that are created from at least one sensor node at every predetermined time unit.

### CROSS REFERENCE TO RELATED APPLICATION

The present application claims priority to Korean patent applications 10-2021-0058319, filed May 6, 2021 and 10-2021-0141828, filed Oct. 22, 2021, the entire contents of which are incorporated herein for all purposes by this reference.

### BACKGROUND OF THE INVENTION

### Field of the Invention

The present disclosure relates to a method and apparatus for data slicing based on an information centric network and, more particularly, to a method and apparatus for collecting data through multiple sensors of a terminal of Internet of Things (IoT) and dynamically slicing the collected data into interrelated datasets with matched time series which are required for artificial intelligence learning or prediction application.

### Description of the Related Art

Conventionally, an IoT terminal periodically collects data through its sensor. In addition, the data are stored in a collecting server of an organization collecting the data, which is either on a cloud or not, through the Internet, and the data thus stored in each organization are provided to users through a web server, an application or the Internet.

Organizations collecting data operate their own IoT terminals and data-collecting servers, and each of those organizations collects, stores and provides data on its own. Each organization occasionally opens collected data through public data sharing websites such as the public data website (data.go.kr). Alternatively, each organization also provides direct services for a data application programming interface (API) through which data are provided restrictively. Such data provided by an organization are used for the learning and prediction of various AI-based applications.

When using the existing IP technology for IoT, the problems of scalability and data security occur. To solve the problems, studies for applying the new scheme named information centric network (ICN) to IoT are actively underway. ICN uses a name of data used in an application instead of an IP address of terminal. Over the last decade, various ICN technologies have been suggested, but the named data network (NDN) scheme currently represents the ICN technology.

It is difficult to extract one or more interrelated different datasets, which are needed for various AI applications, from data that are collected and provided by an IoT terminal. As each dataset collected and opened by an IoT terminal has a different period, it is difficult to make interrelated datasets with matched time series, which are required for AI applications. Furthermore, it is difficult to dynamically create and provide interrelated datasets necessary for AI applications.

In addition, when an ICN is applied to IoT, a name unit of static data may be requested directly to a producer or data may be received by subscribing to a publisher through a broker, but interrelated datasets with matched time series necessary for AI application are difficult to provide, and interrelated datasets are also difficult to dynamically create and provide.

### SUMMARY

The present disclosure is directed to provide a method and apparatus for data slicing for data, which are collected through an IoT terminal, based on an information centric network.

Also, the present disclosure is directed to provide a method and apparatus for dynamically slicing collected data into interrelated datasets with matched time series which are required for artificial intelligence learning or prediction.

Also, the present disclosure is directed to provide a method and apparatus for creating a data slice required by an AI application.

Also, the present disclosure is directed to provide a method and apparatus for publish advertising a data slice required by an AI application.

Also, the present disclosure is directed to provide a method and apparatus for publishing a data slice required by an AI application.

Also, the present disclosure is directed to provide a method and apparatus for unregistering a data slice, as requested by an AI application.

Also, the present disclosure is directed to provide a method and apparatus for unpublishing a data slice, as requested by AI application.

Also, the present disclosure is directed to provide a method and apparatus for deleting a data slice required by an AI application.

Also, the present disclosure is directed to provide a method and apparatus for publish un-advertising a data slice required by an AI application.

Also, the present disclosure is directed to provide a method and apparatus for retrieving a data slice required by an AI application.

Also, the present disclosure is directed to provide a method and apparatus for modifying a data slice required by an AI application.

Also, the present disclosure is directed to provide a method and apparatus for modifying and publishing a data slice required by an AI application.

Other objects and advantages of the present disclosure will become apparent from the description below and will be clearly understood through embodiments of the present disclosure. It is also to be easily understood that the objects and advantages of the present disclosure may be realized by means of the appended claims and a combination thereof.

According to an aspect of the present disclosure, a method for data slicing based on an ICN may be provided. The method may include, by an IoT terminal provided in the ICN system, receiving a creation request for slice data from an application, processing registration of the slice data, and processing publication of the slice data, wherein the slice data may include sensor data that are created from at least one sensor node at every predetermined time unit.

According to another aspect of the present disclosure, an apparatus for data processing based on an ICN may be provided. The apparatus may include an application device configured to request creation of slice data, an IoT terminal device which is connected with at least one sensor node, collects sensor data provided by the at least one sensor node, and creates the slice data requested by the application device based on the sensor data, a data slice broker which processes brokering for providing the slice data to the application device, and a data slice manager device configured to store and manage the slice data.

According to the present disclosure, a method and apparatus for data slicing for data, which are collected through an IoT terminal, based on an information centric network may be provided.

Also, according to the present disclosure, a method and apparatus for dynamically slicing collected data into interrelated datasets with matched time series which are required for artificial intelligence learning or prediction may be provided.

Also, according to the present disclosure, a method and apparatus for creating a data slice required by an AI application may be provided.

Also, according to the present disclosure, a method and apparatus for publish advertising a data slice required by an AI application may be provided.

Also, according to the present disclosure, a method and apparatus for publishing a data slice required by an AI application may be provided.

Also, according to the present disclosure, a method and apparatus for unregistering a data slice, as requested by an AI application, may be provided.

Also, according to the present disclosure, a method and apparatus for unpublishing a data slice, as requested by an AI application, may be provided.

Also, according to the present disclosure, a method and apparatus for deleting a data slice required by an AI application may be provided.

Also, according to the present disclosure, a method and apparatus for publish un-advertising a data slice required by an AI application may be provided.

Also, according to the present disclosure, a method and apparatus for retrieving a data slice required by an AI application may be provided.

Also, according to the present disclosure, a method and apparatus for modifying a data slice required by an AI application may be provided.

Also, according to the present disclosure, a method and apparatus for publishing a modified data slice required by an AI application may be provided.

### BRIEF DESCRIPTION OF THE DRAWINGS

FIG. 1 describes a configuration of a data slicing system based on information centric networking (ICN) according to an embodiment of the present disclosure.

FIG. 2 describes an operation of creating a data slice according to an embodiment of the present disclosure.

FIG. 3 describes a process of publish advertising a data slice according to an embodiment of the present disclosure.

FIG. 4 describes a process of publishing a data slice according to an embodiment of the present disclosure.

FIG. 5 describes a process of deleting a data slice according to an embodiment of the present disclosure.

FIG. 6 describes a process of publish un-advertising a data slice according to an embodiment of the present disclosure.

FIG. 7 shows a flowchart for the process of a data slice manager in a process of creating and publishing a data slice according to an embodiment of the present disclosure.

FIG. 8 shows a flowchart for the process of a data slice broker in a process of creating and publishing a data slice according to an embodiment of the present disclosure.

FIG. 9 shows a flowchart for the process of a data slice manager in a process of deleting and unpublishing a data slice according to an embodiment of the present disclosure.

FIG. 10 is a view exemplifying a process of retrieving a data slice in a data slicing system according to an embodiment of the present disclosure.

FIG. 11 is a view exemplifying a process of modifying a data slice in a data slicing system according to an embodiment of the present disclosure.

FIG. 12 is a view exemplifying a process of publishing a modified data slice in a data slicing system according to an embodiment of the present disclosure.

FIG. 13 illustrates an example configuration of a data slicing device based on an information centric network according to an embodiment of the present disclosure.

### DETAILED DESCRIPTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

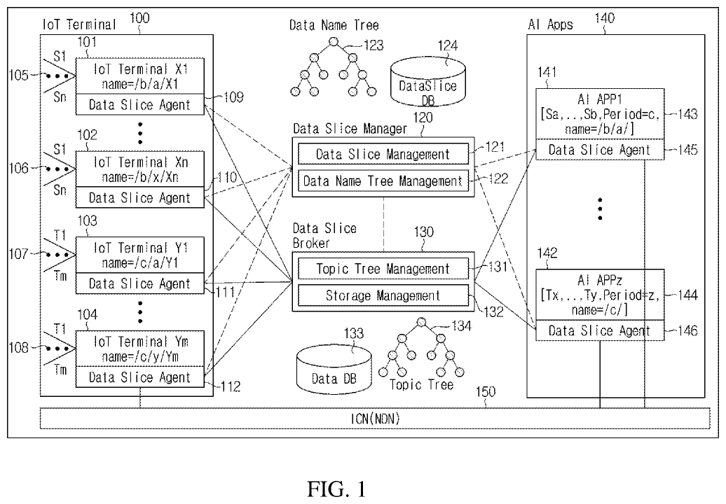

FIG. 1 exemplifies a configuration of a data slicing system based on information centric networking (ICN) according to an embodiment of the present disclosure.

In an Internet of Things (IoT) environment based on ICN, a consumer may forward an interest packet loaded with a name of corresponding data to an ICN router. The ICN router confirms the name of the data in the interest packet and thus may extract forwarding information based on the name of the data. In addition, with reference to a forwarding information base (FIB) table, the ICN router may forward the interest packet toward a producer having the data. Also, the ICN router may manage a pending interest table (PIT) in order to manage the forwarded interest packet. When receiving such an interest packet, the producer having the data may load a data packet with actual encoded data corresponding to the name of the data and forward the data packet to the ICN router. When receiving the data packet from the producer, the ICN router may check the PIT and forward the data packet to the consumer by reversing the path of forwarding the interest packet. When receiving the data packet, the consumer may extract desired data by decoding the encoded data. In the IoT environment, end-to-end communication may be provided through the ICN in order to ensure data security between the consumer and the producer.

In an IoT environment based on ICN, a broker function may be implemented between a consumer and a producer. There may be a broker (or rendezvous node) between a publisher and a subscriber. The publisher may publish every piece of data to a broker, and a subscriber may subscribe to the broker for necessary data. The broker may provide asynchronous communication between the publisher and the subscriber. When the publisher publishes new data, the broker may forward the new data to every subscriber subscribing to the data via ICN multicast communication.

Referring to FIG. 1, a system according to an embodiment of the present disclosure may include at least one or more IoT terminals 100, a data slice manager 120, a data slice broker 130, at least one AI application 140, and ICN (NDN) 150. At least one or more sensor nodes 105 to 108 may be connected to IoT terminals 101 to 104. In addition, the IoT terminals 101 to 104 may include data slice agents 109 to 112.

The data slice manager 120 may perform data slice management 121 and data name tree management 122 and include a data name tree 123 and a data slice database (DB) 124.

The data slice broker 130 may perform topic tree management 131 and storage management 132 and include a data DB 133 and a topic tree 134.

In an embodiment of the present disclosure, the data name tree 123 may include information representing a data structure of a data slice name or sub-name. The data slice manager 120 may check data slice information requested by an AI application by using the data name tree 123. In addition, the topic tree 134 may include information representing a data structure of a data slice name or sub-name. The data slice broker 130 may be used to store and manage a data slice in the data DB 133 using the topic tree 134.

Furthermore, the data name tree 123 and the topic tree 134 may be configured in the same way. In addition, as a data slice name or a sub-name is modified, the data name tree 123 and the topic tree 134 may be updated in connection therewith.

AI applications 141 to 142 may use interrelated datasets 143 to 144 with matched time series for artificial intelligence learning or prediction.

Also, the AI applications 141 to 142 may include data slice agents 145 to 146. When the ICN(NDN) 150 performs communication among the IoT terminal 100, the data slicing manager 120, the data slice broker 130 and the AI application 140, a communication scheme based on a data name may be used.

The IoT terminals 101 to 104 may be connected to one or more different sensor nodes 105 to 108 respectively. As an example, X1 to Xn terminals 101 to 102 may be commonly connected to S1 to Sn sensor nodes 105 to 106, and Y1 to Ym terminals 103 to 104 may be commonly connected to T1 to Tm sensor nodes 107 to 108. In addition, X1 to Xn terminals 101 to 102 and Y1 to Ym terminals 103 and 104 may be connected to a common type of sensor nodes or to different types of sensor nodes. IoT terminals 101 to 104 may manage data, which are collected from the sensor nodes 105 to 108, by using an ICN(NDN)-based name. As an example, IoT terminals 101 to 104 may perform communication with a sensor node by using an ICN(NDN)-based name. For example, IoT terminal X1 101 may have name “/b/a/X1/”, and the sensor nodes (S1 to Sn) 105 connected to the IoT terminal may have names “/b/a/X1/S1/” and “b/a/X1/Sn/” respectively. IoT terminals 101 to 104 may include data slice agents 109 to 112 respectively and exchange a message with the data slice broker 130 and the data slice manager 120 through the data slice agents 109 to 112 by using an NDN scheme.

The data slice manager 120 may provide interrelated datasets with matched time series to AI applications 141 to 142. To this end, the data slice manager 120 may perform the operations of data slice management 121 and data name tree management 122. The data slice manager 120 may include the data name tree 123, which manages data names published by IoT terminals, and the data slice DB 124 which stores data slice information provided to the AI applications 141 to 142.

The data slice broker 130 may provide a function of brokering data and a data slice, which are published by the IoT terminals 101 to 104, to interrelated datasets with time series matched to the AI applications 141 to 142. To this end, the data slice broker 130 may perform the operations of topic tree management 131 and data storage management 132. The data slice broker 130 may include the data DB 133 for storing data, which are published by IoT terminals 101 to 104, and the topic tree 134 for managing a top of data that are published by IoT terminals 101 to 104.

The data slice manager 120 and the data slice broker 130 may exchange a message with IoT terminals 101 to 104 through NDN 150. Also, the data slice manager 120 and the data slice broker 130 may exchange a message with AI applications 141 to 142 through NDN 150. AI applications 141 to 142 may use interrelated datasets with matched time series. Each AI application may perform data transmission and reception by using a name of the AI application, an interrelated dataset, a collection interval of the dataset, and location information 143 to 144 of the dataset. In addition, in order to request interrelated datasets with matched time series, the AI applications 141 to 142 may exchange a data slice management message through communication with the data slice manager 120.

In order to receive interrelated data slice datasets with matched time series, which are published by an IoT terminal, the AI applications 141 to 142 may exchange a message with the data slice broker 130. The AI applications 141 to 142 may exchange a message with the data slice broker 130 and the data slice manager 120 through the data slice agents 145 to 146 in NDN 140.

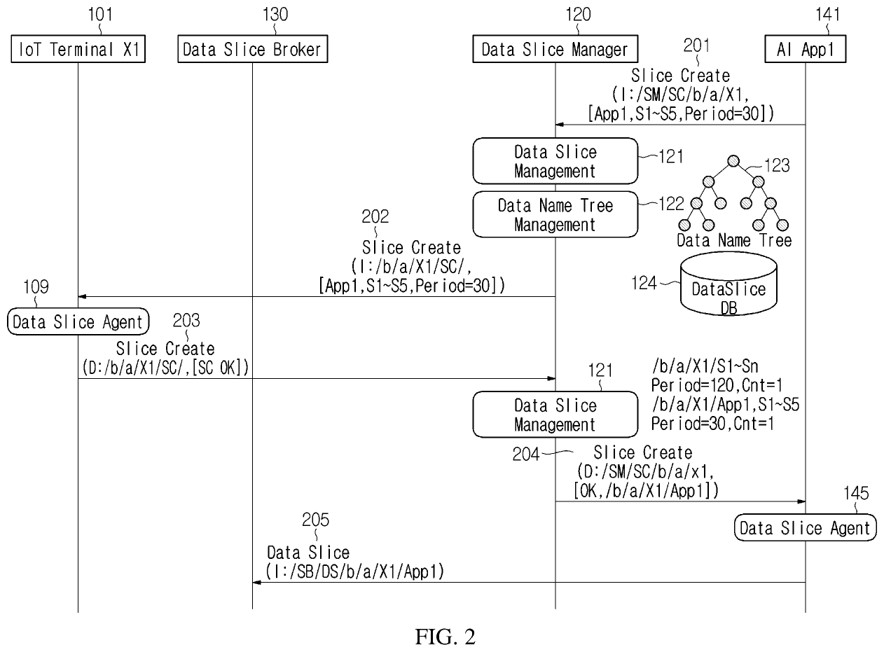

FIG. 2 exemplifies an operation of creating a data slice according to an embodiment of the present disclosure.

In an embodiment of the present disclosure, a message may be transmitted and received between entities provided in an NDN-based data slicing system, and “I:” represents a message transmitted and received through an NDN-type interest packet, and “D:” represents a message transmitted and received through an NDN-type data packet.

The AI application 141 may set up a machine learning model by using interrelated datasets with matched time series or derive an analysis result by applying interrelated datasets with matched time series to a set machine learning model. Accordingly, an AI application may request interrelated datasets with matched time series which are required. As an example, an AI application may request dynamic publication of datasets to IoT terminals 101 to 104. Specifically, the AI application 141 may forward a data slice creation (slice create: SC) message to the data slice manager 120 through the data slice agent 145 (201). Herein, the SC message may be forwarded through an NDN scheme and include location information (/b/a/) or terminal information (/b/a/X1) of data requested by an AI application, AI application information (App1), requested data lists S1 to S5, and collection interval information (30 seconds) of the data.

When receiving a data slice creation message, the data slice manager 120 may perform the operation of data slice management 121 and the operation of data name tree management 122.

When the data slice creation message is received, the data slice DB 124 may be retrieved in the operation of data slice management 121. Through the retrieval of the data slice DB 124, the data slice manager 120 may check whether or not there is an existing data slice with the same application information (App1), data lists S1 to S5, data location (/b/a/) or terminal information (/b/a/X1) and collection interval (30 seconds) as included in the data slice creation message requested by the AI application 141. In case the data slice DB 124 has a same data slice (/b/a/X1/App1) as the data slice requested by the AI application 141, the data slice manager 120 may confirm application counter (Cnt) information of the data slice from information on the data slice of the data slice DB 124. In addition, the data slice manager 120 may increase the application counter (Cnt) of the data slice by one (Cnt=Cnt+1). Also, the data slice manager 120 may store the modified data slice application counter (Cnt) in the information on the data slice of the data slice DB 124. The data slice manager 120 may include the corresponding slice data name (/b/a/X1/App1) in a data slice creation response message and forward the message to the AI application 141.

In case there is no data slice requested by the AI application 141, the data slice manager 120 may perform the operation of data name tree management 122. In the operation of data name tree management 122, the data slice manager 120 may retrieve the data name tree 123. In addition, it may be checked whether or not data location (/b/a/) or terminal information (/b/a/X1), which is requested by the AI application 141, has an IoT terminal providing the data lists S1 to S5 which are requested by the AI application 141. As a result of retrieval, when there is no IoT terminal, which provides the data lists S1 to S5 requested by the AI application 141, in the data location (/b/a/) requested by the AI application 141, the data slice manager 120 may configure a data slice creation response message including “FAIL” value. In addition, the data slice manager 120 may forward the data slice creation response message to the AI application 141 through NDN.

As a result of retrieval, when an IoT terminal providing a data list requested by the AI application 141 is present in a data location requested by the AI application 141, the data slice manager 120 may forward a data slice creation (slice create) message to the corresponding IoT terminal X1 101 (202) Herein, the data slice creation message may include AI application information (App1), corresponding data lists S1 to S5 and data collection interval information (30 seconds). When receiving the data slice creation message, the IoT terminal 101 may perform a process of publish advertising a data slice through the data slice agent 109.

In the process of publish advertising a data slice, the slice agent 109 may create a new AI application data name (/b/a/X1/App1) having a dataset corresponding to a new data slice based on the AI application information (App1), the data lists S1 to S5, and the data collection interval information (30 seconds). In addition, the slice agent 109 may proceed registration to publish information on the data slice and perform a data slice publishing process using a new name (/b/a/X1/App1). During the publish advertising process, the slice agent 109 may publish data lists S1 to S5 corresponding to the data slice at the data collection interval (30 seconds) corresponding to the publish advertising.

The IoT terminal 101 may perform the process of the data slice agent 109, include “SC OK” in the data slice creation response message and forward the message to the data slice manager 120 (203). The data slice manager 120 may receive the data slice creation response message and, when the message content is “SC OK”, perform the process of data slice management 121. In the operation of data slice management 121, when receiving the data slice creation response message, the data slice manager 120 may register new data slice information (data slice name: /b/a/X1/App1, data list: S1 to S5, publication interval: 30 seconds) to the data slice DB 124. In the data slice management 121, the application counter (Cnt) of a corresponding data slice may be initialized to “1”.

The data slice manager 120 may perform the process of data slice management 121, include the new data slice information (/b/a/X1/App1) in a data slice creation response message and forward the message to the AI application 141 through NDN (204). When the data slice creation response message is “SC OK”, the AI application 141 may perform the process of data slice agent 145. For example, based on data slice information included in the data slice creation response message, the data slice agent 145 may forward a data slice request (Data Slice) message to the data slice broker 130 through NDN (205).

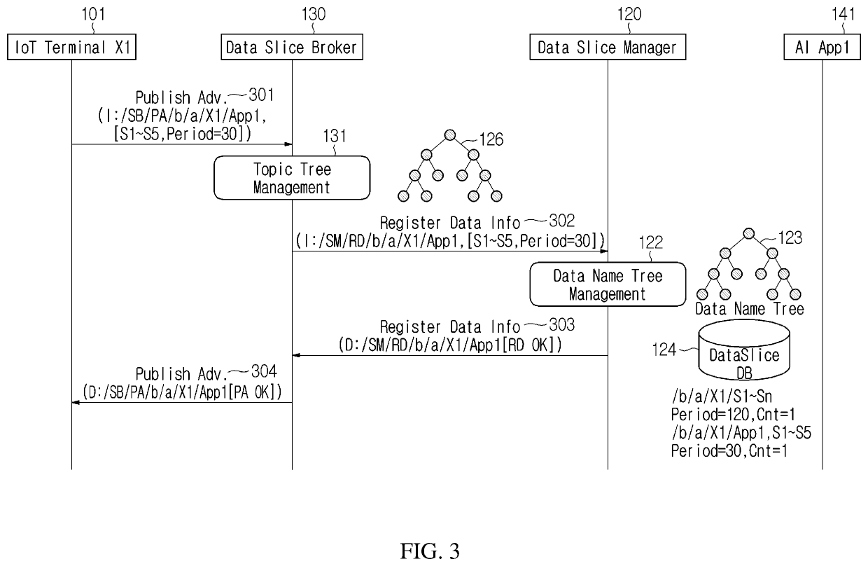

FIG. 3 exemplifies an operation of publish advertising a data slice according to an embodiment of the present disclosure.

Referring to FIG. 3, the IoT terminal 101 may forward a data name registration (publish advertise: PA) message, which includes a new data slice name (/b/a/X1/App1) published in the IoT terminal, data lists S1 to S5 and a data collection interval (30 seconds), to the data slice broker 130. The data name registration message may be forwarded to the data slice broker 130 through a data slice agent in NDN (301). In response to this, the data slice broker 130 may receive the data name registration message and perform the process of topic tree management 131.

In topic tree management 131, an operation of registering the data name (/b/a/X1/App1) to the topic tree 126, which is managed in the data slice broker 130 itself, may be performed. The data slice broker 130 may forward a data information registration (Register Data Info) message to the data slice manager 120 (302). Herein, the data information registration message may include the data slice name (/b/a/X1/App1), data lists S1 to A55, and the data collection interval (30 seconds).

When receiving the data information registration message regarding the new data slice from the data slice broker 130, the data slice manager 120 may perform an operation of data name tree management 122. In data name tree management 122, an operation of registering the data slice name (/b/a/X1/App1) may be performed. When the data name tree management 122 operation is normally performed, the data slice manager 120 may forward a data information registration response message to the data slice broker 130 (303).

The data slice broker 130 may receive the data information registration response message and forward a data name registration response message to the IoT terminal 101 (304). When the data name registration response message is “PA OK”, the IoT terminal 101 may perform a data slice publication process.

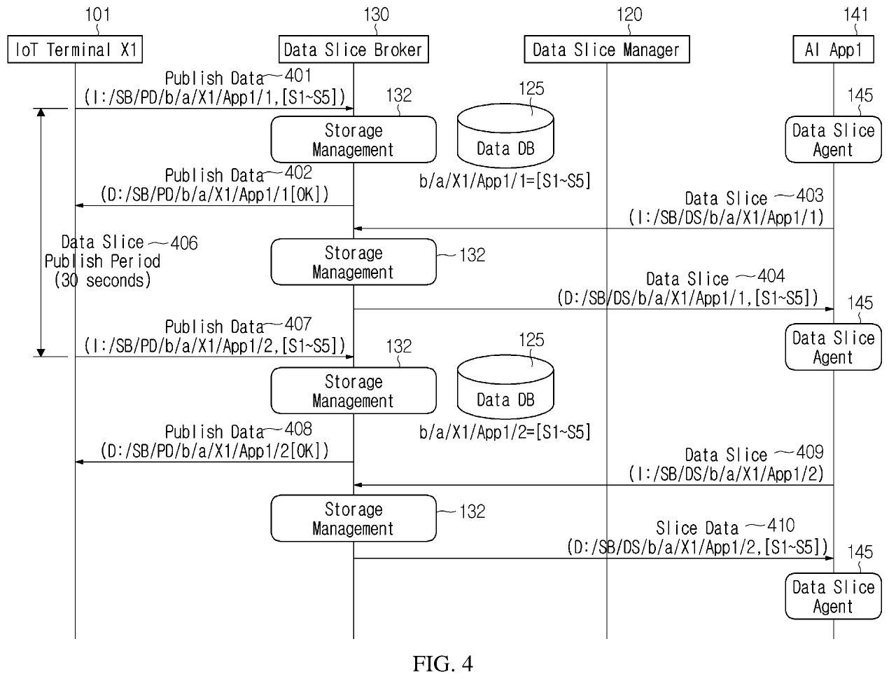

FIG. 4 exemplifies an operation of publishing a data slice according to an embodiment of the present disclosure.

Referring to FIG. 4, the IoT terminal 101 may forward a data publication (publish data: PD) message to the data slice broker 130 through a data slice agent (401). The data publication message may include a data slice name and a data list. When receiving the data publication message, the data slice broker 130 may perform the process of storage management 132.

In storage management 132, a sub-name may be generated by adding a corresponding data slice publication sequence number to the data slice data name (/b/a/X1/App1) in the DB 125 managed by the data slice broker 130. As an example, the data slice broker may configure a sub-name constructed in the form of “b/a/X1/App1/1”. The data slice broker 130 may store a corresponding data slice S1 to S5 by using the sub-name (/b/a/X1/App1/1). When storage management 132 is normally performed, the data slice broker 130 may forward a data publication response message to the IoT terminal 101 (402).

The AI application 141 may make a data slice request through the data slice agent 145. For example, the data slice agent 145 may forward a data slice request message to the data slice broker 130 based on the data slice name (/b/a/X1/App1) that is obtained through an IoT data slice registration process (403). The data slice broker 130 may receive the data slice request message from the AI application 141 and implement the process of storage management 132.

In storage management 132, the data slice name (/b/a/X1/App1) may be retrieved in the data DB 125 that is managed by the data slice broker 130 itself. In addition, data S1 to S5 corresponding to the data slice name may be found. The data slice broker 130 may forward a data slice request response message to the AI application 141 (404). Herein, the data slice request response message may include a value of data S1 to S5 of the data name (/b/a/X1/App1) of a corresponding data slice. The AI application 141 may receive a data slice request response message and implement the process of data slice agent 145. The data slice agent 145 may extract a value of data S1 to S5 of a corresponding data slice included in the message. In addition, the value of data S1 to S5 of the data slice may be used in the AI application.

At every publication interval (30 seconds) 406 of a new data slice, the IoT terminal 101 may implement the data slice publication process 407 to 410 by including data collected from sensors S1 to S5 corresponding to the data slice (/b/a/X1/App1). In the second publication process 407 to 410 of a new data slice, the IoT terminal 101 may publish second data of the data slice. Herein, the IoT terminal 101 may configure a sub-name by modifying the data sequence number from 1 to 2 following the slice data name. Data slices published in the same IoT terminal 101 may be identified through corresponding data sequence numbers.

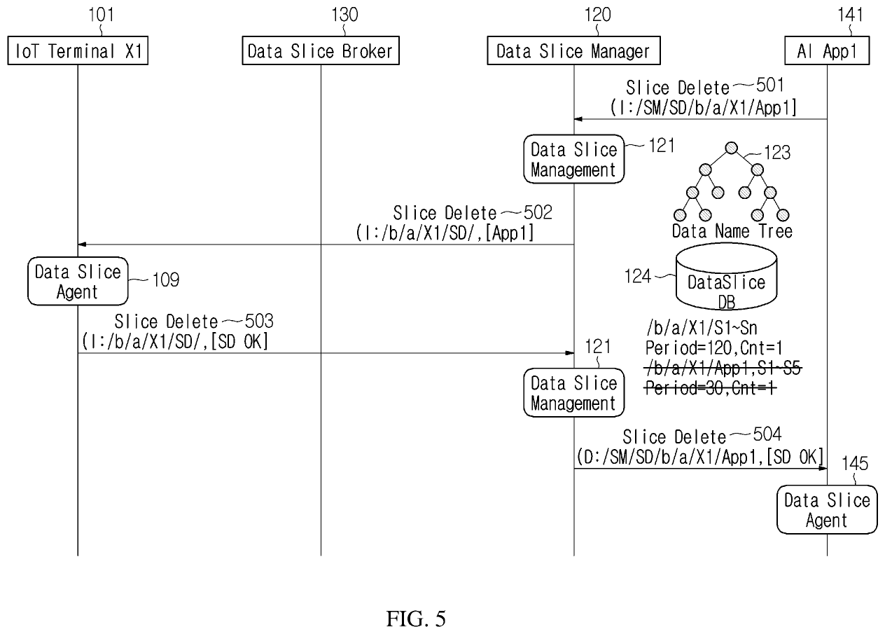

FIG. 5 is a view exemplifying a process of deleting a data slice according to an embodiment of the present disclosure.

Referring to FIG. 5, in order to request unpublication, the AI application 141 may forward a data slice deletion (slice delete: SD) message to the data slice manager 120 through the data slice agent 145 (501). The data slice deletion message may include the existing data slice information (/b/a/X1/App1). The data slice manager 120 may receive the data slice deletion message and implement the process of data slice management 121.

For data slice management 121, the data slice manager 120 may search the data slice DB 124 and check whether or not there is the existing data slice information corresponding to the data slice information (/b/a/X1/App1) included in the slice deletion message. When there is no data slice information (/b/a/X1/App1) which the AI application 141 requests to delete, the data slice manager 120 may include information indicating “FAIL” in a data slice deletion response message. In addition, the data slice manager 120 may forward the data slice deletion response message to the AI application 141.

Meanwhile, when the data slice information (/b/a/X1/App1), of which deletion is requested, is present in the data slice DB 124, the data slice manager 120 may confirm corresponding data slice application counter (Cnt) information from information on the data slice (/b/a/X1/App1) in the data slice DB 124. When the data slice application counter (Cnt) exceeds 1, it may mean that the data slice is used by two or more different AI applications. In response to this, the data slice manager 120 may decrease the data slice application counter (Cnt=Cnt−1). In addition, the modified data slice application counter (Cnt) may be stored in information on the data slice of the data slice DB 124. In addition, the data slice manager 120 may configure and forward a data slice deletion response message including “SD OK” to the AI application 141.

Meanwhile, when data slice application counter (Cnt) is 1, it may mean that the data slice is used only by a corresponding AI application. In addition, when the corresponding AI application sends a data slice unregistration message, it may mean that the data slice is not needed anymore. The data slice manager 120 may forward a data slice deletion (slice delete) message to the IoT terminal 101 (502). The data slice deletion message may include AI application information. When receiving the data slice deletion message, the IoT terminal 101 may perform an operation of deleting a data slice through the data slice agent 109.

The data slice agent 109 may stop collecting periodically data of a corresponding data slice from the IoT terminal 101. In addition, the data slice agent 109 may perform a process of unpublishing an IoT data slice. The IoT terminal 101 may include “SD OK” in a data slice deletion response message and forward the message to the data slice manager 120 (503). In response to this, the data slice manager 120 may check information included in the data slice deletion response message and, when “SD OK” is confirmed, perform the process of data slice management 121.

As an example, when “SD OK” information is confirmed from the data slice deletion response message, the data slice manager 120 may delete corresponding data slice information (/b/a/X1/App1) from the data slice DB 124. In addition, the data slice manager 120 may include “SD OK” in the data slice deletion response message and forward the message to the AI application 141 (505).

The AI application 141 may receive the data slice deletion response message, confirm that “SD OK” information is included in the data slice deletion response message, and stop requesting the slice data.

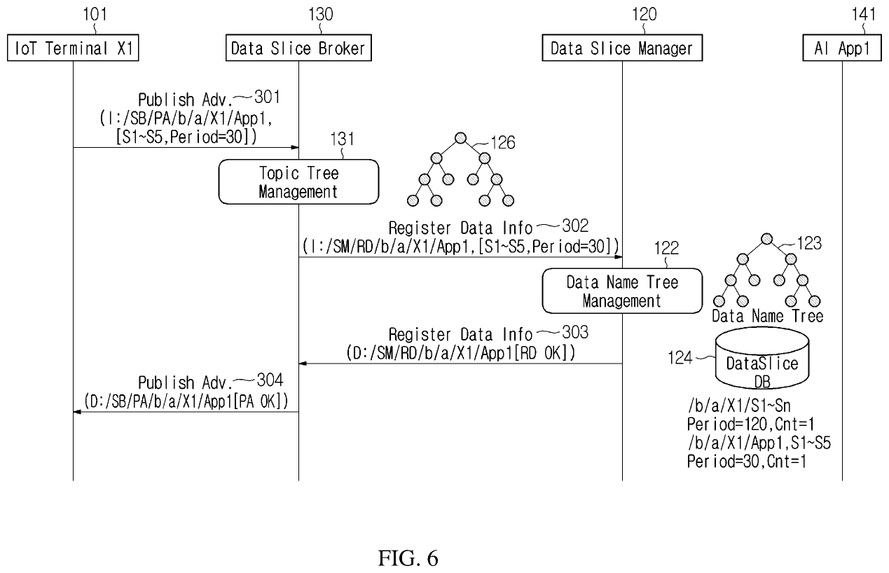

FIG. 6 describes a process of publish un-advertising a data slice according to an embodiment of the present disclosure.

Referring to FIG. 6, the IoT terminal 101 may register the unpublication of an existing data slice, which is published in the IoT terminal, to the data slice broker 130. The IoT terminal 101 may forward a data name unregistration (publish unadvertise: PU) message to the slice broker (601). Herein, the IoT terminal 101 may forward the data name unregistration message through a data slice agent.

When receiving the data name unregistration message from the IoT terminal 101, the data slice broker 130 may perform an operation of topic tree management 131. In the operation of topic tree management 131, a process of deleting a corresponding data name (/b/a/X1/App1) from the topic information tree 126 may be performed.

After performing the process of topic tree management 131, the data slice broker 130 may forward a data information unregistration (Unregister Data Info) message to the data slice manager 120 (602). Herein, the data information unregistration message may include the name of the data slice (/b/a/X1/App1). The data slice manager 120 may receive the data information unregistration message and perform an operation of data name tree management 121. In the operation of data name tree management 121, the data slice management 120 may perform an operation of deleting the data slice name (/b/a/X1/App1) from the data name tree 123.

The data slice manager 120 may perform data name tree management 121 and forward a data information unregistration response message to the data slice broker 130 (603).

The data slice broker 130 may receive the data information unregistration response message and, when the message includes a value indicating “UD OK”, include “OK” in a data name unregistration response message and forward the message to the IoT terminal 101 (604). When the data name unregistration response message is “UD OK”, the IoT terminal 101 may end the process of unpublishing the IoT data slice.

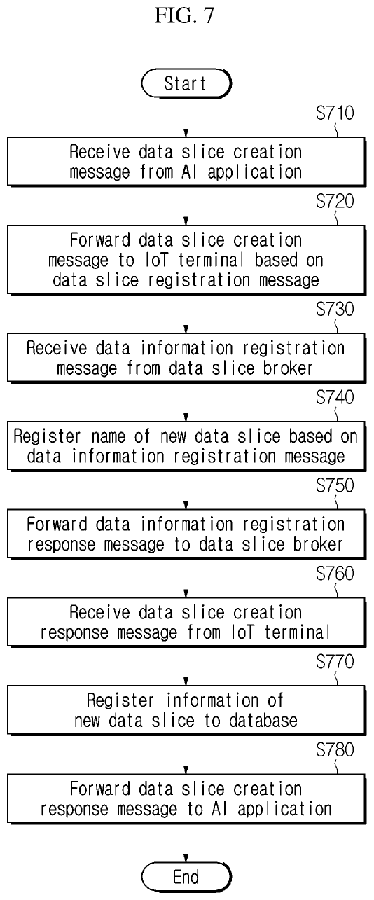

FIG. 7 shows a flowchart for the process of a data slice manager in a process of creating, publish advertising a data slice according to an embodiment of the present disclosure.

Referring to FIG. 7, a data slice creation message may be received from an AI application (S710). In addition, the data slice creation message may be forwarded to an IoT terminal (S720).

According to an embodiment, the data slice creation message may include at least one among data location information, terminal information, AI application information, a data list and a data collection interval.

In addition, a data information registration message may be received from a data slice broker (S730).

According to an embodiment, the data information registration message may include at least one among a slice data name of a new data slice, a data list of the new data slice, and a data collection interval of the new data slice.

In addition, based on the data information registration message, the slice data name of the new data slice may be registered (S740).

In addition, a data information registration response message may be forwarded to a data slice broker (S750).

In addition, a data slice creation response message may be received from an IoT terminal (S760).

In addition, information on the new data slice may be registered in a database (S770).

According to an embodiment, the information on the new data slice may include at least one among a slice data name of the new data slice, a data list of the new data slice, and a publication interval of the new data slice.

In addition, a data slice creation response message may be forwarded to an AI application (S780).

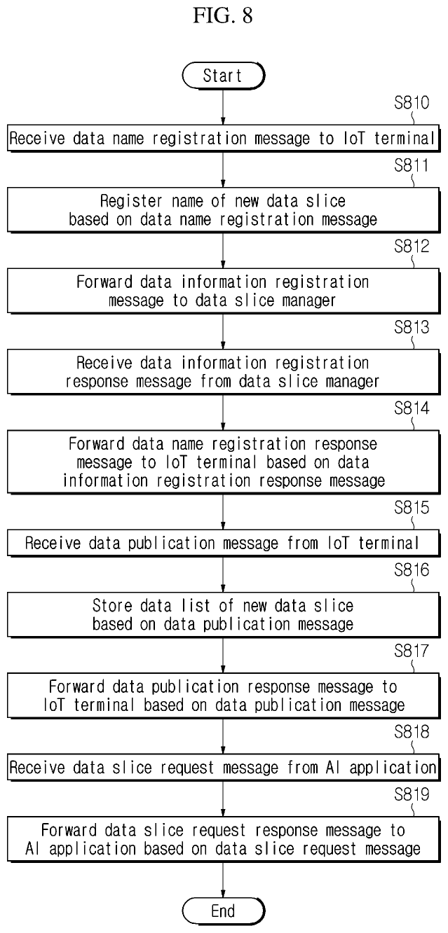

FIG. 8 shows a flowchart for the process of a data slice broker in a process of registering and publishing a data slice according to an embodiment of the present disclosure.

Referring to FIG. 8, a data name registration message may be received from an IoT terminal (S810).

According to an embodiment, the data name registration message may include at least one among a slice data name of a new data slice, a data list of the new data slice, and a data collection interval of the new data slice.

In addition, based on the data name registration message, a name of the new data slice may be registered (S811).

In addition, a data information registration message may be forwarded to a data slice manager (S812).

According to an embodiment, the data information registration message may include at least one among a slice data name of a new data slice, a data list of the new data slice, and a data collection interval of the new data slice.

In addition, a data information registration response message may be received from the data slice manager (S813).

In addition, based on the data information registration response message, a data name registration response message may be forwarded to an IoT terminal (S814).

In addition, a data publication message may be received from the IoT terminal (S815).

According to an embodiment, the data publication message may include at least one of a slice data name of a new data slice and a data list of the new data slice.

In addition, based on the data publication message, the data list of the new data slice may be stored (S816).

According to an embodiment, a sub-name may be configured by adding a publication sequence number to the slice data name of the new data slice. Based on the sub-name with the added publication sequence number, the data list of the new data slice may be stored.

In addition, based on the data publication message, a data publication response message may be forwarded to an IoT terminal (S817).

In addition, a data slice request message may be received from an AI application (S818).

According to an embodiment, the data slice request message may include a new data slice name.

In addition, based on the data slice request message, a data slice request response message may be forwarded to the AI application (S819).

According to one embodiment, a new data slice name may be retrieved in a database. A data list corresponding to the new data slice name may be included in the data slice request message and be forwarded to the AI application.

According to an embodiment, based on a publication interval of the new data slice, a process of publishing the new data slice may be performed.

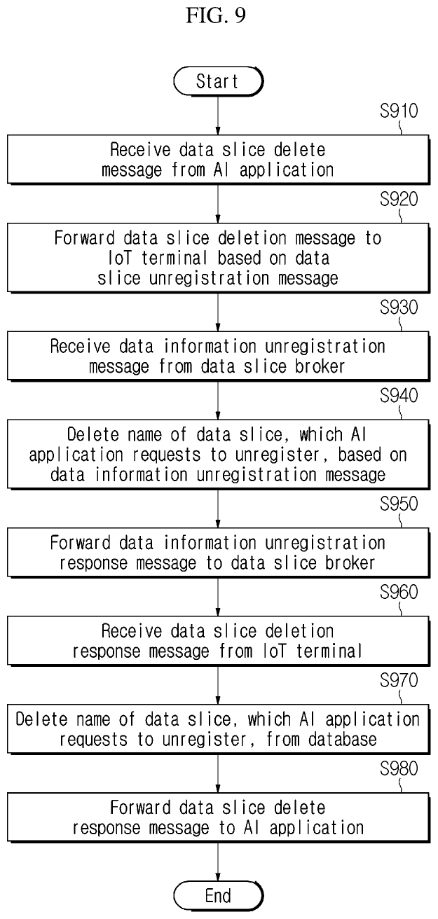

FIG. 9 shows a flowchart for the process of a data slice manager in a process of deleting and unpublishing a data slice according to an embodiment of the present disclosure.

Referring to FIG. 9, a data slice deletion message may be received from an AI application (S910).

According to an embodiment, the data slice deletion message may include a name of a data slice that the AI application requests to delete.

According to an embodiment, the data slice deletion message may include information on the AI application.

In addition, the slice deletion message may be received from a data slice broker (S930).

According to an embodiment, the data slice deletion message may include a data slice name that the AI application requests to unregister.

In addition, based on the data slice deletion message, the data slice name may be deleted which the AI application requests to delete (S940).

In addition, a data slice deletion response message may be forwarded to the data slice broker (S950).

In addition, the data slice deletion response message may be received from an IoT terminal (S960).

In addition, the data slice name, which the AI application requests to delete, may be deleted from a database (S970).

In addition, the data slice deletion response message may be forwarded to the AI application (S980).

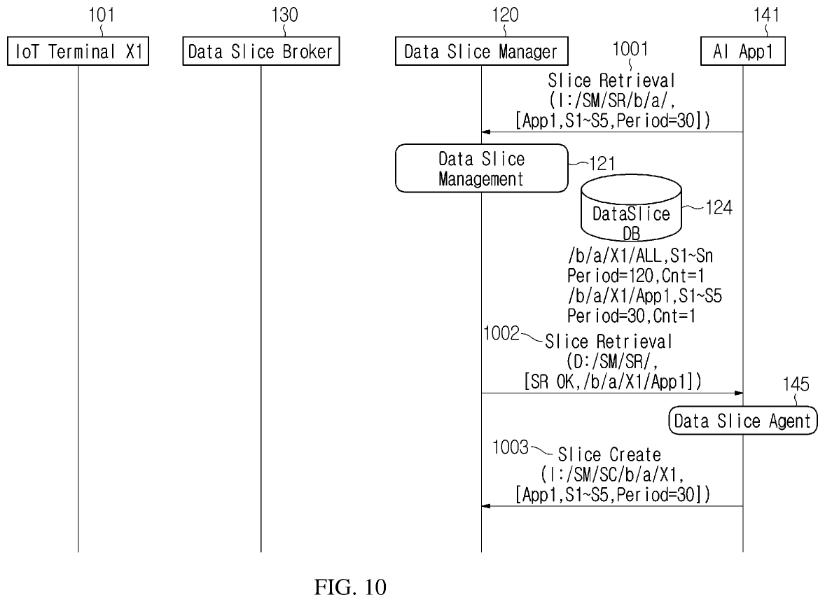

FIG. 10 is a view exemplifying a process of retrieving a data slice in a data slicing system according to an embodiment of the present disclosure.

Referring to FIG. 10, the AI application 141 forwards a data slice retrieval (SR) message to the data slice manager 120 (1001). Herein, the AI application 141 may forward the data slice retrieval message through the data slice agent 145.

The data slice retrieval message may be configured to retrieve a data slice that publishes interrelated datasets S1 to S5 with matched time series required by a corresponding application (App1). As an example, the data slice retrieval message may include a requested data list S1 to S5 and a collection interval (30 seconds).

When receiving the data slice retrieval message, the data slice manager 120 may perform the process of data slice management 121.

In data slice management 121, the data slice DA 124 is searched, and it is checked whether or not there is an existing data slice having the same data slice data list S1 to S5 and collection interval (30 seconds) as requested by the AI application 141.

When there is the same data slice (/b/a/X1/App1) as the one requested by the AI application 141, the data slice manager 120 may include the data slice information (/b/a/X1/App1) in a data slice retrieval (SR) response message and forward the SR response message to the AI application 141 (1002).

When there is no data slice requested by the AI application 141, the data slice manager 120 may configure a data slice (SR) retrieval response message by including information indicating “SR FAIL” and forward the SR retrieval response message to the AI application 141.

The AI application 141 confirms the data slice retrieval response message and performs the process of slice data slice agent 145 as the data slice retrieval response message indicates “SR OK”.

When the data slice retrieval (SR) response message is “SR OK”, the data slice agent 145 may forward a data slice creation (slice create: SC) message to the data slice manager 120 based on data slice information included in the data slice retrieval response message (1003). Herein, the data slice creation message may be forwarded to the data name-based NDN communication 140 through the data slice agent 145.

Preferably, the data slice creation (SC) message may include terminal information of requested data (/b/a/X1), AI application information (App1), a requested data list S1 to S5, and a collection interval (30 seconds) of the data.

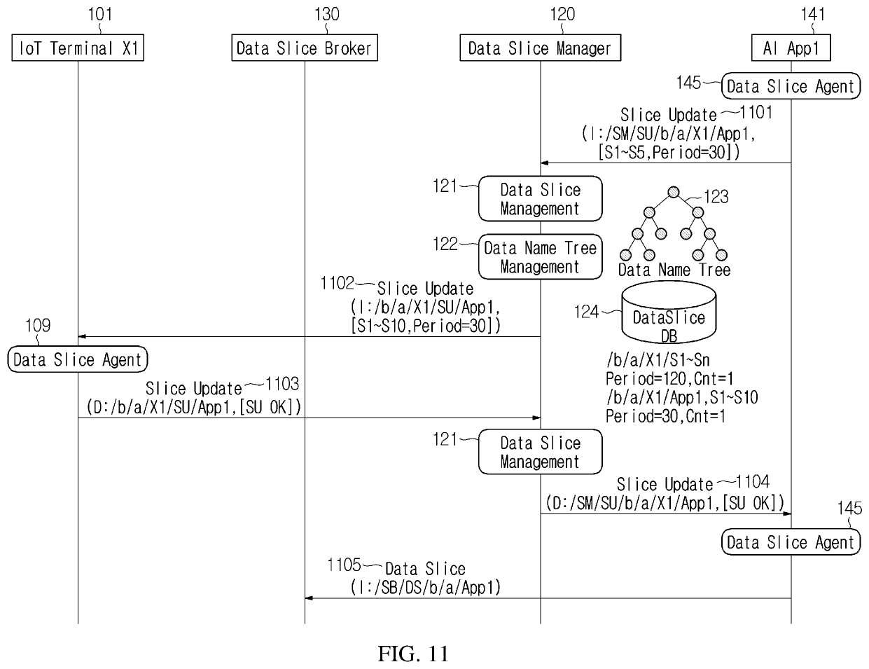

FIG. 11 is a view exemplifying a process of modifying a data slice in a data slicing system according to an embodiment of the present disclosure.

In order to request to modify the data slice datasets S1 to S10 which are dynamically published by the IoT terminals 101 to 104 as requested by the corresponding application (App1), the AI application 141 may forward a data slice modification (slice update: SU) to the data slice manager 120 (1101). Herein, the data slice modification (slice update: SU) message may be forwarded to the data slice manager 120 through the data slice agent 145 via data name-based NDN communication 140 (1101).

Furthermore, the data slice modification (SU) message may include requested data slice information (/b/a/X1/App1), requested data lists S1 to S10, and collection interval information (30 seconds) of the data.

When receiving the data slice modification (SU) message, the data slice manager 120 may perform the process of data slice management 121.

In data slice management 121, based on information included in the data slice modification (SU) message, the data slice DB 124 is searched, and it is checked whether or not there is an existing data slice which the AI application 141 requests to modify.

When there is a same data slice (/b/a/X1/App1) as the one that the AI application 141 requests to modify, the data slice management 121 may forward a data slice modification (slice update: SU) to the corresponding IoT terminal 101 (1102). Herein, the data slice management 121 may include AI application information (App1), corresponding data lists S1 to S10 and data collection interval information (30 seconds) in the data slice modification (slice update: SU) message.

The IoT terminal 101 may receive the data slice modification (SU) message and perform the process of data slice agent 109.

The data slice agent 109 may receive the data slice modification (SU) message and confirm IoT data lists S1 to S10 included in the data SU message.

When the IoT data lists S1 to S10 are data lists S1 to S10 capable of being collected in a corresponding IoT terminal, the IoT terminal may check whether or not it is possible to publish data at the data collection interval (30 seconds) and then may handle a process of modified publication for IoT data slices by means of the existing data name (/b/a/X1/App1).

For example, based on the data lists S1 to S10 corresponding to data slices, the IoT terminal collects and publishes datasets S1 to S10 corresponding to data slices at the data collection interval (30 seconds). In this case, as the existing data name (/b/a/X1/App1) is used, the IoT terminal does not perform the publication and registration process of IoT data slices.

The IoT terminal 101 performs the process of the data slice agent 109, include “SC OK” in the data slice modification (slice update: SU) response message and forward the data SU response message to the data slice manager 120 (1103).

The data slice manager 120 may receive the data SU response message and, when the message is “SU OK”, may perform the process of data slice management 121.

In data slice management 121, when the data SU response message is received from the IoT terminal 101, the existing data slice information (data slice information=/b/a/X1/App1, data list=S1 to S5, publication interval=30 seconds) is modified and registered (data slice information=/b/a/X1/App1, data list=S1 to S10, publication interval=30 seconds).

In data slice management 121, the application counter (Cnt) of the data slice (/b/a/X1/App1) is initialized to “1′.

The data slice manager 120 performs the process of data slice management 121, includes the data slice information (/b/a/X1/App1) in the data SU response message, and forwards the data SU response message to the AI application 141 (1104).

When the data SU response message is “SU OK”, the AI application 141 performs the process of slice data slice agent 145.

When the data SU response message is “SU OK”, the data slice agent 145 forwards a data slice request message to the data slice broker 130 through the data slice agents 145 to 146 based on data slice information included in the data SU response message (1105).

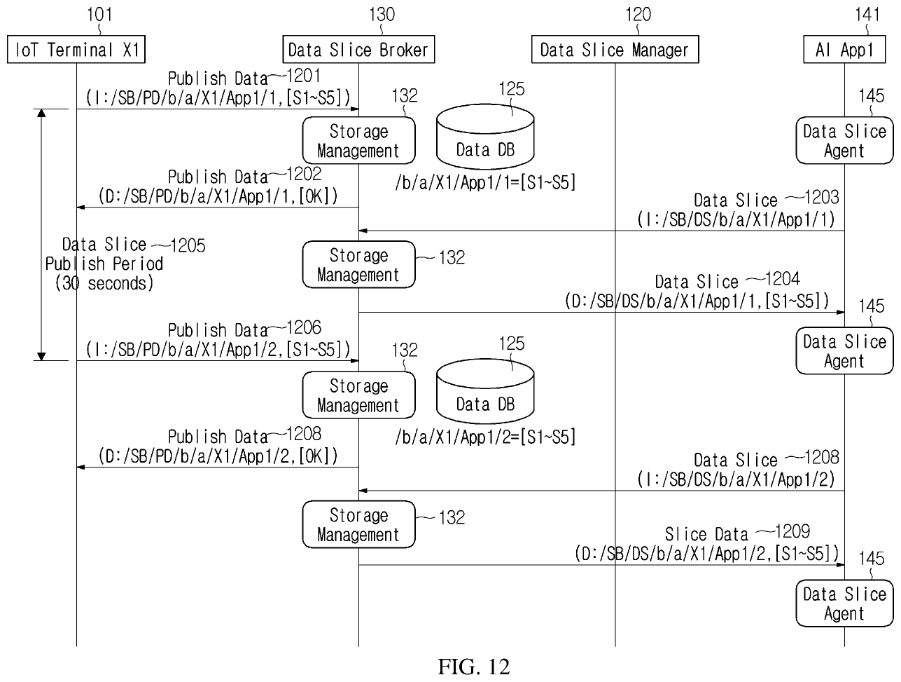

FIG. 12 is a view exemplifying a process of publishing a modified data slice in a data slicing system according to an embodiment of the present disclosure.

The IoT terminal 101 may confirm data collected from sensors S1 to S10 that correspond to the new IoT data slice (/b/a/X1/App1). In addition, the IoT terminal 101 may configure a data publication (Publish Data: PD) message including the collected data and forward the PD message to the data slice broker 130 (1201). Herein, the PD message may be forwarded to the data slice broker 130 through the data slice agent 109.

When receiving the PD message about a new data slice from the terminal 101, the data slice broker 130 may perform the process of storage management 132.

In storage management 132, when the PD message about the new data slice is received, a sub-name (/b/a/X1/App1/1) is created by adding a corresponding data slice publication sequence number to the slice data name (/b/a/X1/App1) in the data DB 125 managed by the data slice broker 130 itself, and thus a process of storing the values of first sensor data S1 to S10 of the data slice is performed using the sub-name (/b/a/X1/App1/1).

When storage management 132 is normally performed, the data slice broker 130 may forward a data publication (PD) response message to the IoT terminal 101 (1202). Herein, the PD response message may be forwarded to the IoT terminal 101 through the data slice agents 109 to 112 based on the data name-based NDN communication 140.

The data slice agent 145 of the AI application 141 forwards a data slice request (Data Slice) message to the data slice broker 130 via the data name-based NDN communication 140 based on the new data slice information (/b/a/X1/App1) which is obtained through an IoT data slice modification process (1203).

When receiving the data slice request message for a new data slice from the AI application 141, the data slice broker 130 may perform the process of storage management 132.

In storage management 132, when the data slice request message for the new data slice is received from the AI application 141, corresponding data S1 to S10 may be retrieved in the data DB 125 which are managed by the data slice broker 130 itself. Herein, retrieval may be performed using the slice data name (/b/a/X1/App1).

The data slice broker 130 may include values of data S1 to S10, which are retrieved in storage management 132, in a corresponding data slice request response message and forward the message to the AI application 141 via the data name-based NDN communication 140 (1204).

The AI application 141 may receive the data slice request response message and implement the process of data slice agent 145.

When receiving the data slice request response message, the data slice agent 145 extracts the values of slice data S1 to S10 included in the message and uses the values in the AI application.

At every publication interval (30 seconds) 905 of a corresponding new IoT data slice, the IoT terminal 101 performs a new IoT data slice publication process 906 to 909 by using data collected from sensors S1 to S5 corresponding to the IoT data slice (/b/a/X1/App1).

In a second publication process 906 to 909 for the new IoT data slice, the IoT terminal 101 may publish second sensor data of the IoT data slice to a data slice broker and modify a data sequence number located at the end of the sub-name of the data slice from “1” to “2”. Data slice data published at a same IoT data slice may be identified through corresponding data sequence numbers.

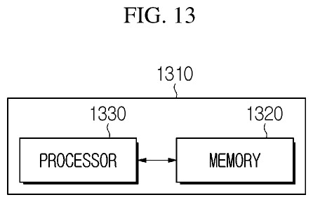

FIG. 13 illustrates an example configuration of a data slicing device based on an information centric network according to an embodiment of the present disclosure.

Referring to FIG. 13, the device 1300 may include a memory 1320 and at least one processor 1330. The memory 1320 may include various volatile or nonvolatile storing media.

The processor 1100 may be a central processing unit or a semiconductor device that processes commands stored in the memory 1320.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. A method for processing data based on an information centric network (ICN) in an ICN system, the method comprising:
by an IoT terminal provided in the ICN system,
receiving a creation request for slice data from an application;
processing registration of the slice data; and
processing publication of the slice data,
wherein the slice data comprises sensor data which are created from at least one sensor node at every predetermined time unit.

2. The method of claim 1, wherein the processing of the registration of the slice data comprises:
creating a slice data name of the slice data; and
registering the slice data by using the slice data name.

3. The method of claim 2, wherein the processing of the registration of the slice data further comprises transmitting, to a data slice broker, a registration request message that comprises at least one among a slice data name of the slice data, a list of the slice data, and a collection interval of the slice data.

4. The method of claim 3, wherein the slice data name comprises information indicating location information of the slice data or location information of a terminal and information indicating the application.

5. The method of claim 3, comprising registering, by the data slice broker, the slice data name.

6. The method of claim 5, comprising transmitting, by the data slice broker, an information registration message, which comprises at least one among the slice data name, the list of the slice data and the collection interval of the slice data, to a data slice manager.

7. The method of claim 1, wherein the processing of the publication of the slice data comprises:
creating at least one sub-name based on the slice data name; and
publishing the slice data by using the at least one sub-name.

8. The method of claim 7, wherein the creating of the at least one sub-name comprises:
checking a creation sequence of the slice data; and
creating the at least one sub-name by adding the creation sequence to the slice data name.

9. The method of claim 6, wherein the publishing of the slice data comprises:
transmitting the slice data to a data slice broker; and
storing, by the data slice broker, the slice data by using the at least one sub-name.

10. The method of claim 9, comprising:
receiving a request of the slice data from the application using the at least one sub-name; and
confirming the slice data corresponding the at least one sub-name and providing the slice data to the application.

11. The method of claim 1, further comprising:
receiving, from the application, a request to delete the slice data by using the slice data name; and
deleting the slice data corresponding to the slice data name.

12. The method of claim 1, further comprising:
receiving a request to unregister publication of the slice data; and
deleting the slice data name corresponding to the slice data in a topic information tree managed by a data slice broker.

13. The method of claim 13, comprising:
requesting, by the data slice broker, a data slice manager to unregister information of the slice data; and
deleting the slice data name corresponding to the slice data in a data name tree managed by the data slice manager.

14. The method of claim 8, comprising performing retrieval of the slice data based on the slice data name.

15. The method of claim 14, comprising:
updating a collection interval of the slice data; and
performing publication of the slice data based on the updated collection interval of the slice data.

16. The method of claim 15, comprising:
initializing the at least one sub-name based on the updated collection interval of the slice data; and
publishing the slice data by using the at least one initialized sub-name.

17. An apparatus for processing data based on an information centric network in an information centric network system, the apparatus comprising:
an application device configured to request creation of slice data,
an IoT terminal device configured to:
be connected with at least one sensor node,
collect sensor data provided by the at least one sensor node, and
create the slice data requested by the application device based on the sensor data,
a data slice broker device configured to process brokering for providing the slice data to the application device, and
a data slice manager device configured to store and manage the slice data.

18. The apparatus of claim 17, wherein the IoT terminal device is further configured to:
create a slice data name of the slice data, and
register the slice data by using the slice data name.

19. The apparatus of claim 18, wherein the IoT terminal device is further configured to:
create at least one sub-name based on the slice data name, and
publish the slice data by using the at least one sub-name.

20. An IoT terminal device comprised in an information centric network system, the IoT terminal device comprising:
a communication unit;
at least one storage medium; and
at least one processor,
wherein the at least one processor is configured to:
be connected with at least one sensor node and collect sensor data provided by the at least one sensor node,
create slice data requested by an application device, and
store the slice data through a data slice broker device and a data slice manager device.
